(19) United States
(12) Patent Application Publication
(10) Pub. No.: US 2022/0170587 A1
(43) Pub. Date: Jun. 2, 2022

(54) Backpack Kickstand Assembly

(71) Applicant: William Silva, Oakdale, CA (US)

(72) Inventor: William Silva, Oakdale, CA (US)

(21) Appl. No.: 17/108,118

(22) Filed: Dec. 1, 2020

(51) Int. Cl. F16M 13/00

(52) U.S. Cl. CPC F16M 13/005; A45F 2004/026

(57) ABSTRACT

A backpack kickstand assembly for supporting a backpack while the backpack is being worn includes a backpack frame that can be worn on a user's back. A backpack is removably mounted to the backpack frame to facilitate the backpack to be carried on the user's back. A kickstand is attachable to the backpack frame and the kickstand is positionable in an extended position to support the weight of the backpack frame while the backpack frame is being worn to facilitate the wearer of the backpack frame to rest. The kickstand is positionable in a retracted position to facilitate the wearer to bear the full weight of the backpack frame.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to kickstand devices and more particularly pertains to a new kickstand device for supporting a backpack while the backpack is being worn. Additionally, the kickstand device can be deployed with the user's foot while the user is wearing the backpack. In this way the user can deploy the kickstand device without assistance in order to rest while the user is wearing the backpack.

### (2) Description of Related Art including information disclosed under 37 CFR 1.97 and 1.98

The prior art relates to kickstand devices including a telescopic walking cane that is biased into an extended position. The prior art discloses a variety of backpack support frames that includes at least a pair of telescopic legs which are positionable to form an A-frame to support a backpack when the backpack is not being worn. The prior art discloses a combination backpack and chair device that has telescopic legs. The prior art further discloses a backpack support device that includes a stand which is telescopically integrated into a backpack frame. In no instance does the prior art disclose a single, telescopic kickstand which can be retrofitted onto any existing backpack frame.

### BRIEF SUMMARY OF THE INVENTION

An embodiment of the disclosure meets the needs presented above by generally comprising a backpack frame that can be worn on a user's back. A backpack is removably mounted to the backpack frame to facilitate the backpack to be carried on the user's back. A kickstand is attachable to the backpack frame and the kickstand is positionable in an extended position to support the weight of the backpack frame while the backpack frame is being worn to facilitate the wearer of the backpack frame to rest. The kickstand is positionable in a retracted position to facilitate the wearer to bear the full weight of the backpack frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a backpack kickstand assembly according to an embodiment of the disclosure.

FIG. 2 is a right side view of a kickstand of an embodiment of the disclosure.

FIG. 3 is a bottom view of a kickstand of an embodiment of the disclosure.

FIG. 4 is a front phantom view of a kickstand of an embodiment of the disclosure.

FIG. 5 is a left side view of a kickstand of an embodiment of the disclosure.

FIG. 6 is a perspective in-use view of an embodiment of the disclosure.

### DETAILED DESCRIPTION OF THE INVENTION

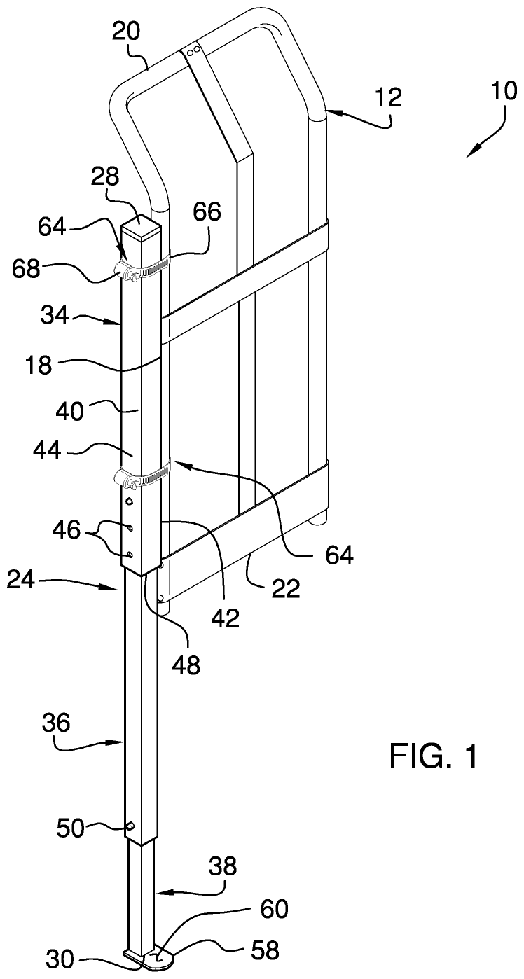

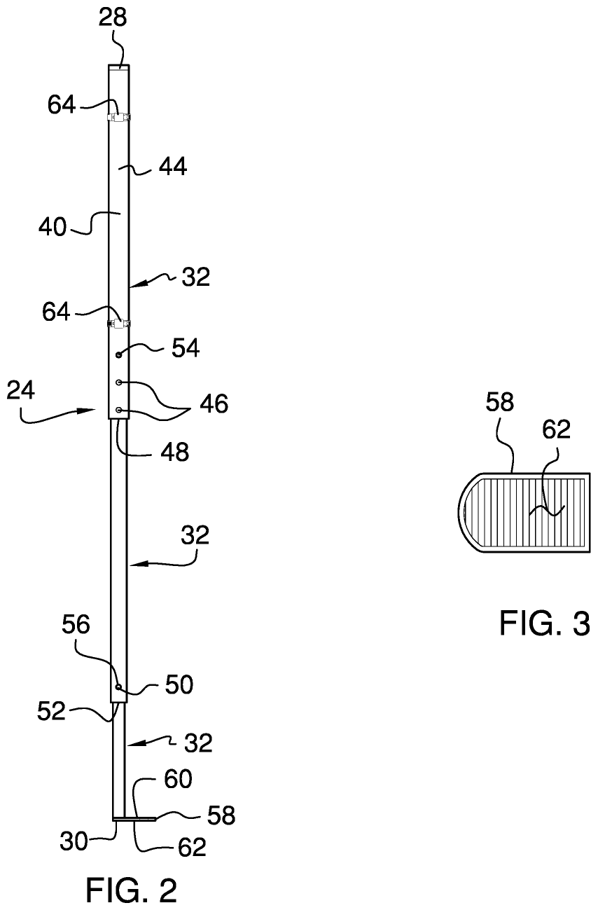

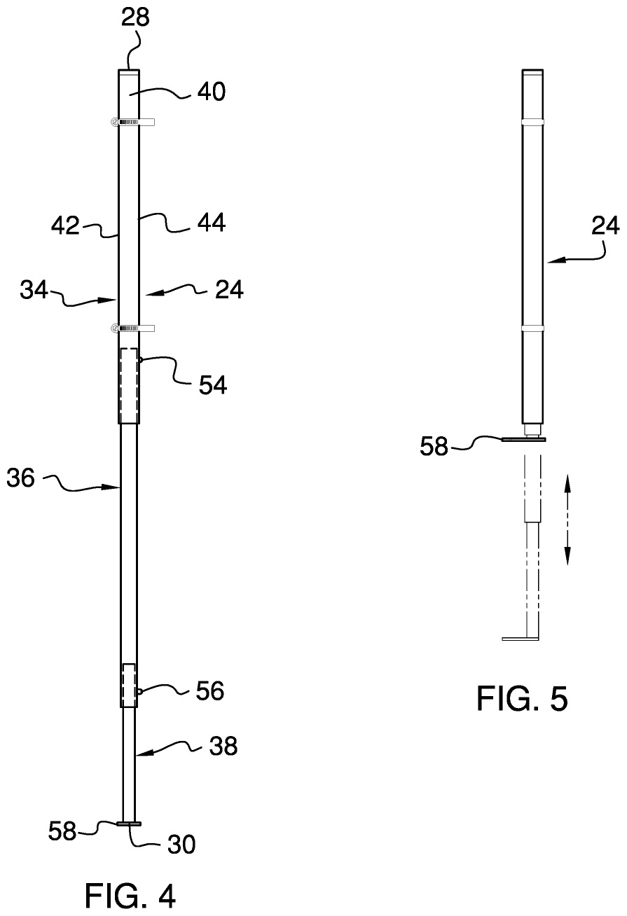

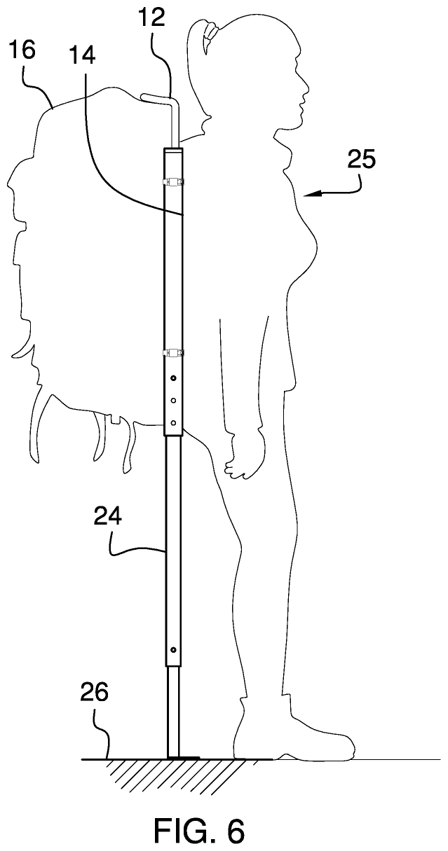

With reference now to the drawings, and in particular to FIGS. 1 through 6 thereof, a new kickstand device embodying the principles and concepts of an embodiment of the disclosure and generally designated by the reference numeral 10 will be described.

As best illustrated in FIGS. 1 through 6, the backpack kickstand assembly 10 generally comprises a backpack frame 12 that can be worn on a user's back 14. A backpack 16 is removably mounted to the backpack frame 12 thereby facilitating the backpack 16 to be carried on the user's back 14. The backpack 16 may be a backpack of any conventional design, including but not being limited to, a hiking backpack, a camping backpack or a military backpack. The backpack frame 12 has an outer member 18 that is vertically oriented between an upper member 20 and a lower member 22. Moreover, the backpack frame 12 may be a backpack frame of any conventional design and size that at least includes an outer member.

A kickstand 24 is provided and the kickstand 24 is attachable to the backpack frame 12. The kickstand 24 is positionable in an extended position having the kickstand 24 extending downwardly from the backpack frame 12. In this way the kickstand 24 can abut a support surface 26 thereby supporting the weight of the backpack frame 12 while the backpack frame 12 is being worn. Thus, the user 25 of the backpack frame 12 can rest while wearing the backpack frame 12. Additionally, the kickstand 24 is positionable in a retracted position to facilitate the user 25 to bear the full weight of the backpack frame 12.

The kickstand 24 has a first end 28 and a second end 30, and the kickstand 24 comprises a plurality of sections 32 that each slidably receives each other such that the kickstand 24 has a telescopically adjustable length. The plurality of sections 32 includes an upper section 34, a middle section 36 and a lower section 38. The upper section 34 has the first end 28 being associated therewith and the lower section 38 has the second end 30 being associated therewith. Additionally, each of the plurality of sections 32 has an outer wall 40, and the outer wall 40 of each of the plurality of sections 32 has a first lateral side 42 and a second lateral side 44. The first lateral side 42 of the outer wall 40 of the upper section 34 is positioned against the outer member 18 of the backpack 16 having the upper section 34 being oriented coextensive with the outer member 18.

The second lateral side 44 of the outer wall 40 of the upper section 34 has a plurality of holes 46 each extending therethrough. The holes 46 are spaced apart from each other and are distributed from a terminal end 48 of the upper section 34 toward the first end 28. The second lateral side 44 of the outer wall 40 of the middle section 36 has an aperture 50 extending therethrough, and the aperture 50 is positioned adjacent to a terminal end 52 of the middle section 36. The middle section 36 is retracted into the upper section 34 when the kickstand 24 is positioned in the retracted position and the lower section 38 is retracted into the middle section 36 when the kickstand 24 is positioned in the retracted section. Conversely, the middle section 36 extends outwardly from the upper section 34 when the kickstand 24 is positioned in the extended position and the lower section 38 extends outwardly from the middle section 36 when the kickstand 24 is positioned in the extended position.

A first lock 54 is movably integrated into the second lateral side 44 of the outer wall 40 of the middle section 36 and the first lock 54 releasably engages a respective one of the holes 46 in the second lateral side 44 of the outer wall 40 of the upper section 34. In this way the first lock 54 facilitates the user to adjusting a distance that the middle section 36 extends from the upper section 34 when the kickstand 24 is positioned in the extended position. The first lock 54 is depressible to disengage the respective hole 46 thereby facilitating the kickstand 24 to be positioned into the retracted position.

A second lock 56 is movably integrated into the second lateral side 44 of the outer wall 40 of the lower section 38. The second lock 56 releasably engages the aperture 50 in the second lateral side 44 of the outer wall 40 of the middle section 36 to retain lower section 38 in an extended orientation with respect to the middle section 36. The second lock 56 is depressible to disengage the respective aperture 50 thereby facilitating the kickstand 24 to be positioned in the retracted position. Each of the first lock 54 and the second lock 56 may comprise a ball that is biased outwardly from the kickstand 24 with a spring or the like.

A foot 58 is coupled to the kickstand 24 and the foot 58 rests on the support surface 26 when the kickstand 24 is positioned in the retracted position. The foot 58 has a top surface 60 and a bottom surface 62, and the top surface 60 is coupled to the second end 30 of the kickstand 24. Thus, the bottom surface 62 abuts the support surface 26 when the kickstand 24 is positioned in the extended position. The bottom surface 62 is textured to facilitate the bottom surface 62 to frictionally engage the support surface 26 thereby inhibiting the foot 58 from sliding on the support surface 26. A textured pad may be coupled to the bottom surface 62 of the kickstand 24 or the bottom surface 62 of the kickstand 24 may have a plurality of grooves embedded therein.

A plurality of couplers 64 is provided and each of the couplers 64 extends around the kickstand 24 and the backpack frame 12 to removably retain the kickstand 24 on the backpack frame 12. Each of the couplers 64 extends around the upper section 34 of the kickstand 24 and the outer member 18 of the backpack frame 12. Additionally, each of the couplers 64 comprises a band 66 and a tightener 68, and the band 66 is extendable through the tightener 68 having the band 66 forming a closed loop around the upper section 34 and the outer member 18. The tightener 68 is actuatable in a first direction to decrease a diameter of the closed loop formed by the band 66 and the tightener 68. Conversely, the tightener 68 is actuatable in a second direction to increase the diameter of the closed loop formed by the band 66 and the tightener 68. Each of the couplers 64 may comprise a hose clamp, a releasable zip tie or any other type of coupler that is formable into a closed loop and that is tightenable or loosenable.

In use, the kickstand 24 is attached to the backpack frame 12 with the couplers 64. The user 25 lifts their heel 70 to push downwardly on the foot 58 that is attached to the kickstand 24 in order to urge the kickstand 24 into the extended position. In this way the user 25 can rest the weight of the backpack 16 on the kickstand 24 to rest without having to take the backpack frame 12 off of their back 14. The user 25 depresses each of the first lock 54 and the second lock 56 to facilitate the kickstand 24 to be positioned into the retracted position to facilitate the user 25 to continue hiking or walking.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A backpack kickstand assembly for supporting the weight of a backpack while a wearer of the backpack is resting, said assembly comprising:
a backpack frame being configured to be worn on a user's back, said backpack frame having a backpack being removably mounted thereto wherein said backpack frame is configured to facilitate the backpack to be carried on the user's back;
a kickstand being attachable to said backpack frame, said kickstand being positionable in an extended position having said kickstand extending downwardly from said backpack frame wherein said kickstand is configured to abut a support surface thereby supporting the weight of said backpack frame while said backpack frame is being worn to facilitate the wearer of said backpack frame to rest, said kickstand being positionable in a retracted position wherein said kickstand is configured to facilitate the wearer to bear the full weight of said backpack frame;
a foot being coupled to said kickstand wherein said foot is configured to rest on the support surface when said kickstand is positioned in said retracted position; and
a plurality of couplers, each of said couplers extending around said kickstand and said backpack frame to removably retain said kickstand on said backpack frame, each of said couplers extending around said upper section of said kickstand and said outer member of said backpack frame, each of said couplers comprising a band and a tightener, said band being extendable through said tightener having said band forming a closed loop around said upper section and said outer member, said tightener being actuatable in a first direction to decrease a diameter of said closed loop formed by said band and said tightener, said tightener being actuatable in a second direction to increase the diameter of said closed loop formed by said band and said tightener.

2. The assembly according to claim 1, wherein said kickstand has a first end and a second end, said kickstand comprising a plurality of sections each slidably receiving each other such that said kickstand has a telescopically adjustable length, said plurality of sections including an upper section, a middle section and a lower section, said upper section having said first end being associated therewith, said lower section having said second end being associated therewith, each of said plurality of sections having an outer wall, said outer wall of each of said plurality of sections having a first lateral side and a second lateral side.

3. The assembly according to claim 2, wherein:
said backpack frame has an outer member being vertically oriented between an upper member and a lower member; and
said first lateral side of said outer wall of said upper section is positioned against said outer member of said backpack having said upper section being oriented coextensive with said outer member.

4. The assembly according to claim 2, wherein said second lateral side of said outer wall of said upper section has a plurality of holes each extending therethrough, said holes being spaced apart from each other and being distributed from a terminal end of said upper section toward said first end.

5. The assembly according to claim 2, wherein said second lateral side of said outer wall of said middle section having an aperture extending therethrough, said aperture being positioned adjacent to a terminal end of said middle section.

6. The assembly according to claim 2, wherein said middle section is retracted into said upper section when said kickstand is positioned in said retracted position, said lower section being retracted into said middle section when said kickstand is positioned in said retracted section, said middle section extending outwardly from said upper section when said kickstand is positioned in said extended position, said lower section extending outwardly from said middle section when said kickstand is positioned in said extended position.

7. The assembly according to claim 4, further comprising a first lock being movably integrated into said second lateral side of said outer wall of said middle section, said first lock releasably engaging a respective one of said holes in said second lateral side of said outer wall of said upper section for adjusting a distance that said middle section extends from said upper section when said kickstand is positioned in said extended position, said first lock being depressible to disengage said respective hole thereby facilitating said kickstand to be positioned into said retracted position.

8. The assembly according to claim 5, further comprising:
a first lock being movably integrated into said kickstand; and
a second lock being movably integrated into said second lateral side of said outer wall of said lower section, said second lock releasably engaging said aperture in said second lateral side of said outer wall of said middle section to retain lower section in an extended orientation with respect to said middle section, said second lock being depressible to disengage said respective aperture thereby facilitating said kickstand to be positioned in said retracted position.

9. The assembly according to claim 2, wherein said foot has a top surface and a bottom surface, said top surface being coupled to said second end of said kickstand wherein said bottom surface is configured to abut the support surface when said kickstand is positioned in said extended position.

10. The assembly according to claim 9, wherein said bottom surface of said foot is textured wherein said bottom surface is configured to frictionally engage the support surface thereby inhibiting said foot from sliding on the support surface.

11. A backpack kickstand assembly for supporting the weight of a backpack while a wearer of the backpack is resting, said assembly comprising:
a backpack frame being configured to be worn on a user's back, said backpack frame having a backpack being removably mounted thereto wherein said backpack frame is configured to facilitate the backpack to be carried on the user's back, said backpack frame having an outer member being vertically oriented between an upper member and a lower member;
a kickstand being attachable to said backpack frame, said kickstand being positionable in an extended position having said kickstand extending downwardly from said backpack frame wherein said kickstand is configured to abut a support surface thereby supporting the weight of said backpack frame while said backpack frame is being worn to facilitate the wearer of said backpack frame to rest, said kickstand being positionable in a retracted position wherein said kickstand is configured to facilitate the wearer to bear the full weight of said backpack frame, said kickstand having a first end and a second end, said kickstand comprising a plurality of sections each slidably receiving each other such that said kickstand has a telescopically adjustable length, said plurality of sections including an upper section, a middle section and a lower section, said upper section having said first end being associated therewith, said lower section having said second end being associated therewith, each of said plurality of sections having an outer wall, said outer wall of each of said plurality of sections having a first lateral side and a second lateral side, said first lateral side of said outer wall of said upper section being positioned against said outer member of said backpack having said upper section being oriented coextensive with said outer member, said second lateral side of said outer wall of said upper section having a plurality of holes each extending therethrough, said holes being spaced apart from each other and being distributed from a terminal end of said upper section toward said first end, said second lateral side of said outer wall of said middle section having an aperture extending therethrough, said aperture being positioned adjacent to a terminal end of said middle section, said middle section being retracted into said upper section when said kickstand is positioned in said retracted position, said lower section being retracted into said middle section when said kickstand is positioned in said retracted section, said middle section extending outwardly from said upper section when said kickstand is positioned in said extended position, said lower section extending outwardly from said middle section when said kickstand is positioned in said extended position;
a first lock being movably integrated into said second lateral side of said outer wall of said middle section, said first lock releasably engaging a respective one of said holes in said second lateral side of said outer wall of said upper section for adjusting a distance that said middle section extends from said upper section when said kickstand is positioned in said extended position, said first lock being depressible to disengage said respective hole thereby facilitating said kickstand to be positioned into said retracted position;
a second lock being movably integrated into said second lateral side of said outer wall of said lower section, said second lock releasably engaging said aperture in said second lateral side of said outer wall of said middle section to retain lower section in an extended orientation with respect to said middle section, said second lock being depressible to disengage said respective aperture thereby facilitating said kickstand to be positioned in said retracted position;
a foot being coupled to said kickstand wherein said foot is configured to rest on the support surface when said kickstand is positioned in said retracted position, said foot having a top surface and a bottom surface, said top surface being coupled to said second end of said kickstand wherein said bottom surface is configured to abut the support surface when said kickstand is positioned in said extended position, said bottom surface being textured wherein said bottom surface is configured to frictionally engage the support surface thereby inhibiting said foot from sliding on the support surface; and
a plurality of couplers, each of said couplers extending around said kickstand and said backpack frame to removably retain said kickstand on said backpack frame, each of said couplers extending around said upper section of said kickstand and said outer member of said backpack frame, each of said couplers comprising a band and a tightener, said band being extendable through said tightener having said band forming a closed loop around said upper section and said outer member, said tightener being actuatable in a first direction to decrease a diameter of said closed loop formed by said band and said tightener, said tightener being actuatable in a second direction to increase the diameter of said closed loop formed by said band and said tightener.

12. A backpack kickstand system for supporting the weight of a backpack while a wearer of the backpack is resting, said system comprising:
a backpack frame being configured to be worn on a user's back, said backpack frame having an outer member being vertically oriented between an upper member and a lower member;
a backpack being removably mounted to said backpack frame wherein said backpack frame is configured to facilitate the backpack to be carried on the user's back;
a kickstand being attachable to said backpack frame, said kickstand being positionable in an extended position having said kickstand extending downwardly from said backpack frame wherein said kickstand is configured to abut a support surface thereby supporting the weight of said backpack frame while said backpack frame is being worn to facilitate the wearer of said backpack frame to rest, said kickstand being positionable in a retracted position wherein said kickstand is configured to facilitate the wearer to bear the full weight of said backpack frame, said kickstand having a first end and a second end, said back pack comprising a plurality of sections each slidably receiving each other such that said kickstand has a telescopically adjustable length, said plurality of sections including an upper section, a middle section and a lower section, said upper section having said first end being associated therewith, said lower section having said second end being associated therewith, each of said plurality of sections having an outer wall, said outer wall of each of said plurality of sections having a first lateral side and a second lateral side, said first lateral side of said outer wall of said upper section being positioned against said outer member of said backpack having said upper section being oriented coextensive with said outer member, said second lateral side of said outer wall of said upper section having a plurality of holes each extending therethrough, said holes being spaced apart from each other and being distributed from a terminal end of said upper section toward said first end, said second lateral side of said outer wall of said middle section having an aperture extending therethrough, said aperture being positioned adjacent to a terminal end of said middle section, said middle section being retracted into said upper section when said kickstand is positioned in said retracted position, said lower section being retracted into said middle section when said kickstand is positioned in said retracted section, said middle section extending outwardly from said upper section when said kickstand is positioned in said extended position, said lower section extending outwardly from said middle section when said kickstand is positioned in said extended position;
a first lock being movably integrated into said second lateral side of said outer wall of said middle section, said first lock releasably engaging a respective one of said holes in said second lateral side of said outer wall of said upper section for adjusting a distance that said middle section extends from said upper section when said kickstand is positioned in said extended position, said first lock being depressible to disengage said respective hole thereby facilitating said kickstand to be positioned into said retracted position;
a second lock being movably integrated into said second lateral side of said outer wall of said lower section, said second lock releasably engaging said aperture in said second lateral side of said outer wall of said middle section to retain lower section in an extended orientation with respect to said middle section, said second lock being depressible to disengage said respective aperture thereby facilitating said kickstand to be positioned in said retracted position;
a foot being coupled to said kickstand wherein said foot is configured to rest on the support surface when said kickstand is positioned in said retracted position, said foot having a top surface and a bottom surface, said top surface being coupled to said second end of said kickstand wherein said bottom surface is configured to abut the support surface when said kickstand is positioned in said extended position, said bottom surface being textured wherein said bottom surface is configured to frictionally engage the support surface thereby inhibiting said foot from sliding on the support surface; and
a plurality of couplers, each of said couplers extending around said kickstand and said backpack frame to removably retain said kickstand on said backpack frame, each of said couplers extending around said upper section of said kickstand and said outer member of said backpack frame, each of said couplers comprising a band and a tightener, said band being extendable through said tightener having said band forming a closed loop around said upper section and said outer member, said tightener being actuatable in a first direction to decrease a diameter of said closed loop formed by said band and said tightener, said tightener being actuatable in a second direction to increase the diameter of said closed loop formed by said band and said tightener.
